(19) United States
(12) Patent Application Publication
(10) Pub. No.: US 2015/0343308 A1
(43) Pub. Date: Dec. 3, 2015

(54) APPARATUS AND METHOD FOR PROVIDING USER INTERFACE FOR CLIENT DEVICES OF CLOUD GAME SERVICES

(71) Applicant: ELECTRONICS AND TELECOMMUNICATIONS RESEARCH INSTITUTE, Daejeon (KR)

(72) Inventors: Su Young BAE, Daejeon (KR); Chang Sik CHO, Daejeon (KR); Hun Joo LEE, Daejeon (KR)

(21) Appl. No.: 14/726,286

(22) Filed: May 29, 2015

(30) Foreign Application Priority Data
May 30, 2014 (KR) 10-2014-0066557

(51) Int. Cl. A63F 13/355; A63F 13/73; A63F 13/85; G06F 3/0484

(52) U.S. Cl. CPC A63F 13/355; G06F 3/04842; G06F 3/04847; A63F 13/73; A63F 13/85

(57) ABSTRACT

The present disclosure provides a game user interface (UI) script server, including: a game UI script generator, which in response to a request of a registrant terminal, is configured to provide a web interface for generating a user interface (UI), and to support generation of game UI scripts; a game UI script storage configured to store the generated game UI scripts through the web interface; and a game UI script provider, which in response to a request of a client terminal, is configured to provide one or more game UI scripts stored in the game UI script storage.

### CROSS-REFERENCE TO RELATED APPLICATION(S)

This application claims priority from Korean Patent Application No. 10-2014-0066557, filed on May 30, 2014, in the Korean Intellectual Property Office, the entire disclosure of which is incorporated herein by reference for all purposes.

### BACKGROUND

1. Field

The following description generally relates to a user interface technology, and more particularly to an apparatus and method for providing a user interface for cloud game services.

2. Description of the Related Art

As smartphones and tablet terminals are widely used, and Internet home appliances, such as smart TVs, are widely distributed, there is an increasing demand for PC game services anytime and anywhere, which requires high-performance rendering.

In order to meet such demand, the cloud game services are provided in such a manner that games, which require many resources of CPU, GPU, memory, and the like, are executed in a cloud server, and once an image of an executed game is transmitted to a client terminal by real-time encoding and streaming, the client terminal displays the streamed game image to a user, and transmits a signal input from a user to a cloud server.

A cloud game execution server, which is a high-performance server computer, uses PC input and output devices, whereas a terminal that receives a cloud game service is a terminal, such as a smartphone, a tablet, a smart TV, and the like, and provides a touch input environment and a limited menu button in a different manner from a PC input device.

Specifically, in the case where a touch keypad included in a smartphone or a tablet terminal is used for keyboard input, a game screen is covered by the keypad, hindering the game. Further, while the Smart TV includes an input device, such as a mini keypad, a joystick, or the like, such input device may not be used in the same manner as an input device of a mouse or a keyboard.

### SUMMARY

Provided is an apparatus and method for providing a user interface for cloud game services, in which an input interface may be provided appropriately for various terminal environments, while separately managing a group of various input keys provided for each game, and input in a client terminal may be converted into an instruction input by a keyboard or a mouse of a cloud game server.

In one general aspect, there is provided a game UI script server, including: a game UI script generator, which in response to a request of a registrant terminal, is configured to provide a web interface for generating a user interface (UI), and to support generation of game UI scripts; a game UI script storage configured to store the generated game UI scripts through the web interface; and a game UI script provider, which in response to a request of a client terminal, is configured to provide one or more game UI scripts stored in the game UI script storage.

In another general aspect, there is provided a client terminal, including: a game script downloader configured to be connected to a game user interface (UI) script server to display a script list, and to download in real time a game UI script determined by a user; a UI generator configured to generate a game input menu skin by analyzing input keys defined in the downloaded game UI script, and positions of the input keys on a screen; a user input receiver configured to receive a user input through the generated UI; an input mapper configured to convert an input signal received by the user input receiver into an input signal used in a game server; a communicator configured to transmit the input signal converted by the input mapper to the game server, and to receive a streamed game image to which an event is applied according to the input signal.

### BRIEF DESCRIPTION OF THE DRAWINGS

FIG. 1 is a block diagram illustrating an example of a system for generating and providing a game user interface script according to an exemplary embodiment.

FIG. 2 is a diagram illustrating an example of a web interface for generating a cloud game user interface according to an exemplary embodiment.

FIG. 3 is a diagram illustrating an example of a game user interface script according to an exemplary embodiment.

FIG. 4 is a diagram explaining an example of a cloud game client terminal according to an exemplary embodiment.

FIG. 5 is a diagram illustrating an example of a game client including three input modes according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, an apparatus and method for controlling water quality sensor faults will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the present disclosure, an input interface is provided appropriately for terminal environments in various cloud game client terminals, and in order to separately manage a group of various input keys provided for each game, input interfaces for each terminal and each game are managed by defining the input interfaces as scripts. Further, button icons to be displayed to a user, arrangement positions of icons on a screen, and events input by a connected mouse or keyboard are defined in the scripts, and an external script server is provided separately to enable users to design an input user interface according to their needs.

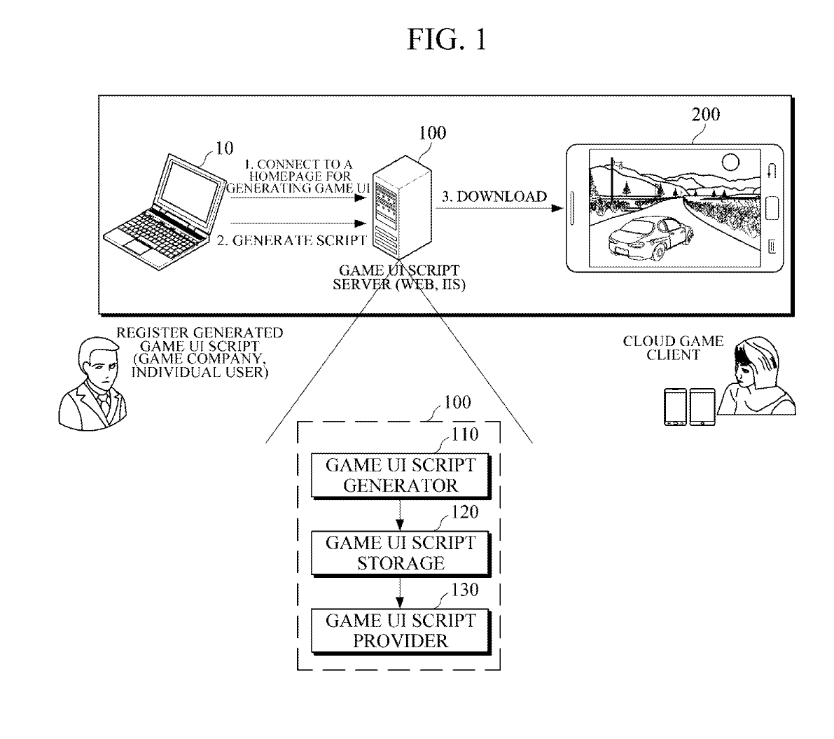

FIG. 1 is a block diagram illustrating an example of a system for generating and providing a game user interface script according to an exemplary embodiment.

Referring to FIG. 1, a user interface script server (hereinafter referred to as a “server”) 100 supports generation of a game UI script of a registrant terminal 10, such as a game company or an individual user that wishes to register a game UI script. That is, a game company may generate and register a cloud game client interface for their games, or a user may access the server 100 to generate a game UI that is appropriate for themselves. In response to a request of a client terminal 200 that uses cloud games, the server 100 may download a generated game UI script.

Specifically, the server 100 includes a game UI script generator 110, a game UI script storage 120, and a game UI script provider 130.

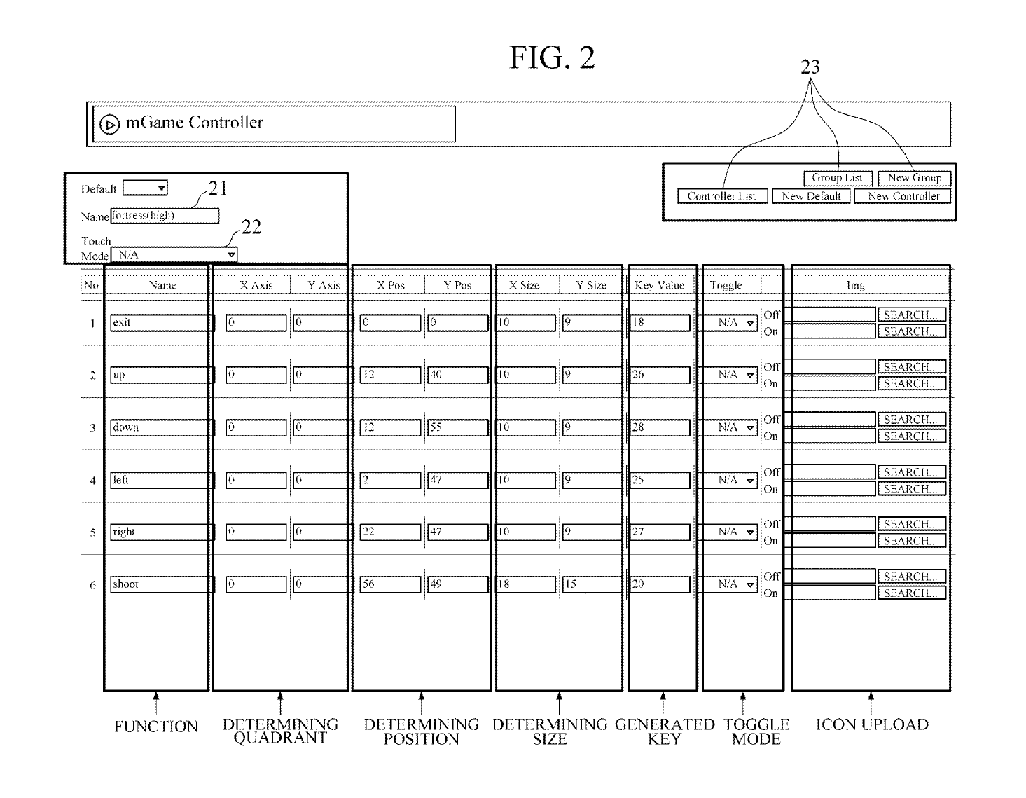

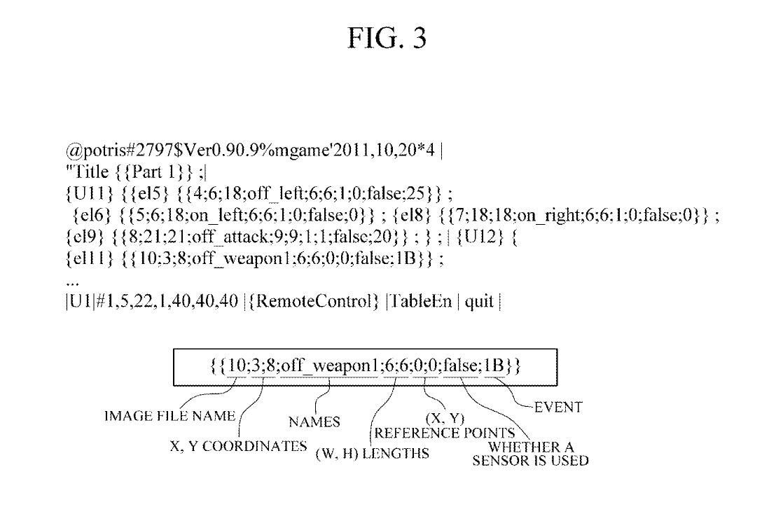

Once a game company or an individual user accesses a game UI homepage using the registrant terminal 10, the game UI script generator 110 provides a web interface for generating a game UI script, so that a game UI may be generated through the provided web interface. The web page for generating a game UI and a game UI script will be described in detail later with reference to FIGS. 2 and 3.

The game UI script storage 120 stores generated game UI scripts by separating the game UI scripts into groups.

In response to a request of the client terminal 200, the game UI script provider 130 provides a screen for selecting a game UI script through a website, and downloads a game UI script selected by a user.

FIG. 2 is a diagram illustrating an example of a web interface for generating a cloud game user interface according to an exemplary embodiment.

Referring to FIG. 2, a registrant may select a game UI name 21 to be used as a tool for generating a game UI script; may determine whether to use a touch interface 22, and determine names of button icons to be used instead of specific game keys; and may determine a quadrant on which these icons are to be disposed, X/Y coordinates, sizes, icon images to be used, a toggle mode, key values to be transmitted to a server, and the like. Upon setting all functions and menus, a group 23, to which a script to be generated belongs, is selected and stored. The group enables a desired script, such as a terminal, resolution, games, and the like, to be retrieved from a terminal when the terminal is connected to a server.

FIG. 3 is a diagram illustrating an example of a game user interface script according to an exemplary embodiment.

Referring to FIG. 3, names of image files, (x, y) coordinates, (w, h) lengths, (x, y) reference points, whether a sensor is used or not, and event names are displayed.

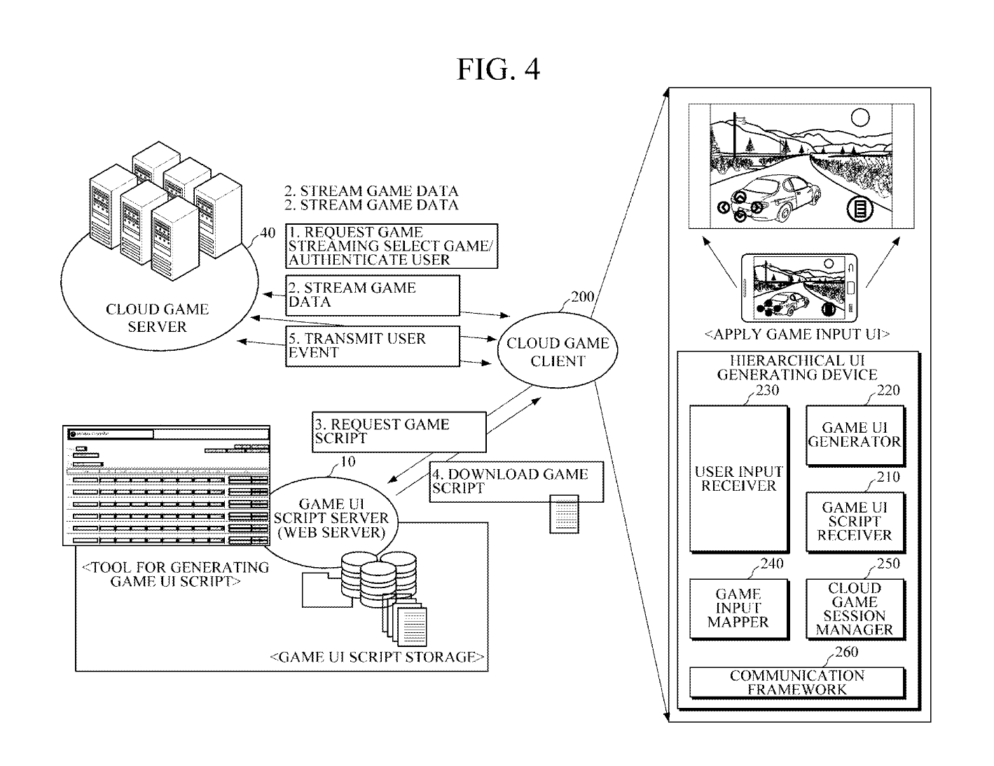

FIG. 4 is a diagram explaining an example of a cloud game client terminal according to an exemplary embodiment.

Referring to FIG. 4, when a UI for a new game provided from a cloud game server 40 is required, or a new UI that is appropriate for the cloud game client terminal 200 is required, a cloud game client terminal (hereinafter referred to as a “terminal”) 200 is connected to the game UI script server 110 to download stored game UI scripts.

The terminal 200 analyzes a downloaded game UI script, and a hierarchical UI generating device of a cloud game client provides a screen that is appropriate for each terminal.

In order to provide many game input keys for each game in various terminal input environments, the hierarchical UI generating device includes a game UI script receiver 210, a game UI generator 220, a user input receiver 230, a game input mapper 240, a cloud game session manager 250, and a communication framework 260.

In response to a user's request for a new game UI script from the server 100, the game input script receiver 210 is connected to the server 100 to display lists of game scripts that are appropriate for each terminal, and downloads in real time a game UI script determined by a user.

The game input UI generator 220 generates a game input menu skin by analyzing input keys defined according to details of a downloaded game UI script, and positions of the input keys on a screen.

The user input 230 receives events in a skin input menu from a game user.

The input event mapper 240 converts a signal input by the user input receiver 230 into a game input signal to be used in a game server. The converted input signal is transmitted to the game server 30 to be applied to a streaming game service, and the cloud game session manager 250 is provided with a streaming game service screen to which events are applied.

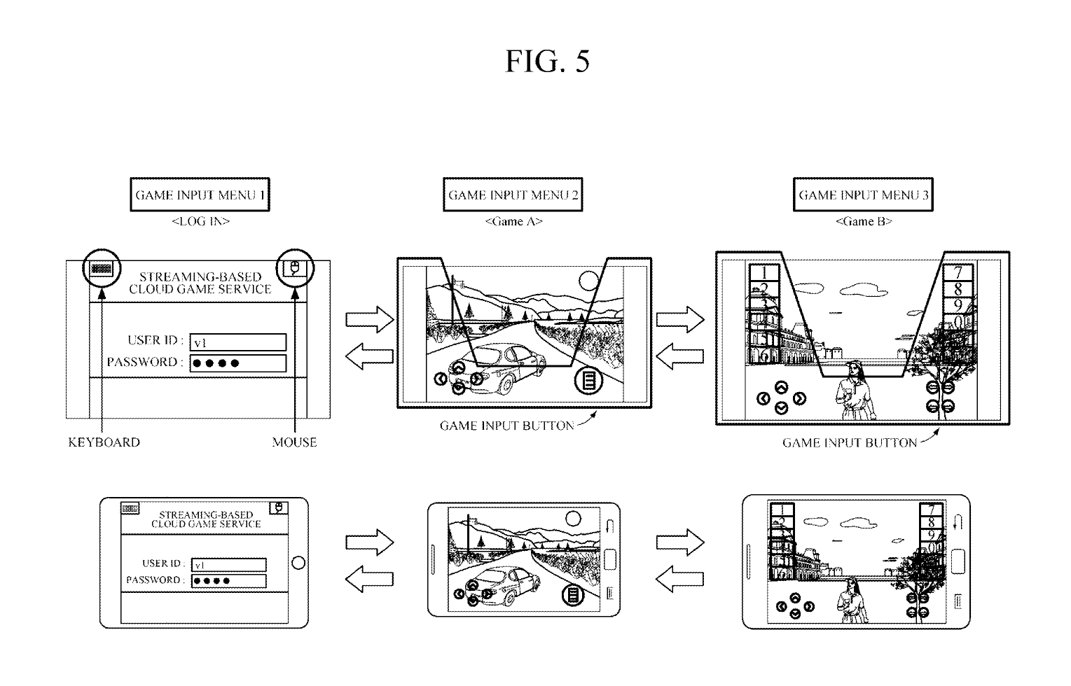

Every time a user downloads a new game or a new UI, a hierarchical UI generating device stores the newly downloaded game or UI so that a user may use them anytime they wish. Specifically, the game UI generator 210 generates downloaded scripts in several pages so that these scripts may be applied any time a user wishes. Each input mode is configured in a hierarchical structure of pages, such that when two fingers of a user slide at the same time, pages move up and down or to the left and right according to sliding directions, which will be described below with reference to FIG. 5.

FIG. 5 is a diagram illustrating an example of a game client including three input modes according to an exemplary embodiment.

FIG. 5 illustrates a basic input menu screen provided for the case where keyboard/mouse input is required, such as logging-in; a GameA input mode in which a simple input, such as a casual game, is required; and a GameB input mode in which a complex key input, such as MMORPG, is required. Each input mode is configured in a hierarchical structure of pages, such that when two fingers of a user slide at the same time, pages move up and down or to the left and right according to sliding directions.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A game UI script server, comprising:
a game UI script generator, which in response to a request of a registrant terminal, is configured to provide a web interface for generating a user interface (UI), and to support generation of game UI scripts;
a game UI script storage configured to store the generated game UI scripts through the web interface; and
a game UI script provider, which in response to a request of a client terminal, is configured to provide one or more game UI scripts stored in the game UI script storage.

2. The server of claim 1, wherein the web interface comprises lists of information including at least one or more of the following: names of game UI scripts; whether to use a touch interface; names of button icons to be used instead of specific game keys; a quadrant on which these icons are to be disposed; X/Y coordinates; sizes; icon images to be used; a toggle mode; and key values to be transmitted to a server.

3. The server of claim 1, wherein the script storage stores game UI scripts by separating the scripts into groups according to characteristics.

4. A client terminal, comprising:
a game script downloader configured to be connected to a game user interface (UI) script server to display a script list, and to download in real time a game UI script determined by a user;
a UI generator configured to generate a game input menu skin by analyzing input keys defined in the downloaded game UI script, and positions of the input keys on a screen;
a user input receiver configured to receive a user input through the generated UI;
an input mapper configured to convert an input signal received by the user input receiver into an input signal used in a game server; and
a communicator configured to transmit the input signal converted by the input mapper to the game server, and to receive a streamed game image to which an event is applied according to the input signal.

5. The client terminal of claim 4, wherein the UI generator separates the downloaded game UI scripts into several pages, so as to apply sliding to the game UI scripts in response to a user's request for another UI.

6. A method of providing a User Interface (UI) for cloud game services, the method comprising:
in response to a request of a registrant terminal, providing a web interface for generating a UI, supporting generation of game UI scripts;
storing the generated game UI scripts through the web interface; and
in response to a request of a client terminal, providing one or more game UI scripts stored in the game UI script storage.

7. The method of claim 6, wherein the web interface comprises lists of information including at least one or more of the following: names of game UI scripts; whether to use a touch interface; names of button icons to be used instead of specific game keys; a quadrant on which these icons are to be disposed; X/Y coordinates; sizes; icon images to be used; a toggle mode;
and key values to be transmitted to a server.

8. The method of claim 6, wherein the storing comprises game UI scripts by separating the scripts into groups according to characteristics.

9. A method of providing a User Interface (UI), the method comprising:
connecting to a game user interface (UI) script server to display a script list and downloading in real time game UI scripts determined by a user;
generating a game input menu skin by analyzing input keys defined in the downloaded game UI scripts, and positions of the input keys on a screen;
receiving a user input through the generated UI;
converting an input signal into an input signal used in a game server;
transmitting the input signal to the game server, and receiving a streamed game image to which an event is applied according to the input signal.

10. The method of claim 9, wherein the generating comprises generating the downloaded game UI scripts in several pages, so as to apply sliding to the game UI scripts in response to a user's request for another UI.
